(19) United States
(12) Patent Application Publication
(10) Pub. No.: US 2024/0172305 A1
(43) Pub. Date: May 23, 2024

(54) MULTI CARRIER AGGREGATION ADDITION AND ACTIVATION TIMELINE OPTIMIZATION

(71) Applicant: QUALCOMM Incorporated, San Diego, CA (US)

(72) Inventors: Kiran PATIL, San Diego, CA (US); Amit MANDIL, Morena (IN); Dileep BAPAT, Hyderabad (IN); Ajay Vignesh JAYAPRAKASH, San Diego, CA (US); Varun NUGGEHALLI ASHOK, San Marcos, CA (US); Jeongho SEO, San Diego, CA (US); Gurmeet Singh KUMAR, San Diego, CA (US); Sushmita Suresh RAO, San Diego, CA (US)

(21) Appl. No.: 18/058,681

(22) Filed: Nov. 23, 2022

(51) Int. Cl. H04W 76/15

(52) U.S. Cl. CPC H04W 76/15

(57) ABSTRACT

An apparatus for wireless communication, the apparatus configured to configured to receive a RRC reconfiguration request associated with CA; perform a first set of RRC reconfiguration operations associated with a first set of physical layer parameters in response to the RRC reconfiguration request; transmit, based on completing performing the first set of RRC reconfiguration operations, an RRC reconfiguration complete indication; and perform, after transmitting the RRC reconfiguration complete indication, a second set of RRC reconfiguration operations associated with a second set of parameters other than the first set of physical layer parameters. In certain aspects, the apparatus may be configured to schedule, in response to the RRC reconfiguration request, at least one gap in uplink transmission and downlink reception via a PCC to coincide with one or more time periods based on a known configuration for communication with a network node associated with the carrier aggregation.

### TECHNICAL FIELD

The present disclosure relates generally to communication systems, and more particularly, to a multi-carrier aggregation for wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE) or a component of a UE configured to receive a radio resource control (RRC) reconfiguration request associated with carrier aggregation (CA). The apparatus may further be configured to perform a first set of RRC reconfiguration operations associated with a first set of physical layer parameters in response to the RRC reconfiguration request. The apparatus may also be configured to transmit, based on completing performing the first set of RRC reconfiguration operations, an RRC reconfiguration complete indication and perform, after transmitting the RRC reconfiguration complete indication, a second set of RRC reconfiguration operations associated with a second set of parameters other than the first set of physical layer parameters.

In an aspect of the disclosure, a method, a computer-readable medium, and an apparatus are provided. The apparatus may be a UE or a component of a UE configured to receive a RRC reconfiguration request associated with carrier aggregation. The apparatus may further be configured to schedule, in response to the RRC reconfiguration request, at least one gap in uplink transmission and downlink reception via a primary carrier to coincide with one or more time periods based on a known configuration for communication with a network node associated with the carrier aggregation.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating a timeline for a RRC reconfiguration request 401 associated with a CA in accordance with some aspects of the disclosure.

FIG. 5 is a call flow diagram illustrating a first method for wireless communication in accordance with some aspects of the disclosure.

FIG. 6 is a call flow diagram illustrating a second method for wireless communication in accordance with some aspects of the disclosure.

FIG. 7 is a diagram illustrating two options associated with implementing the second method described in relation to FIG. 6.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an apparatus.

### DETAILED DESCRIPTION

In some aspects of wireless communication, e.g., a RRC reconfiguration operation may be associated with a time limit between a RRC reconfiguration request and a RRC reconfiguration complete. After the time limit, a base station may transmit an activation indication associated with the RRC reconfiguration request. For a RRC reconfiguration request associated with carrier aggregation, the time limit may be shorter than a time for completing radio frequency (RF) tuning. RF tuning operations associated with secondary component carriers (SCC) other than a primary component carrier (PCC) of the carrier aggregation may be associated with interruptions to reception via the primary component carrier. In some aspects, the interruptions may coincide with an activation indication associated with the RRC reconfiguration request such that the activation indication is not received and the RRC reconfiguration may fail (e.g., a SCC associated with the activation indication may not be activated). Methods and apparatus are provided to reduce the likelihood of failed RRC reconfigurations.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

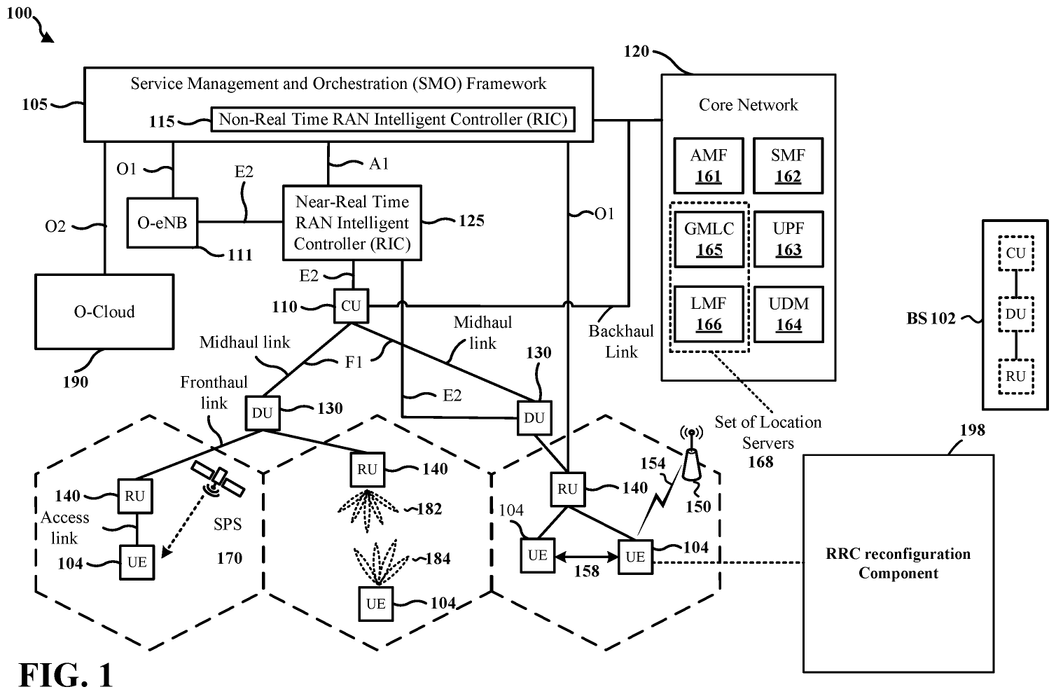

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a RRC reconfiguration component 198 that may be configured to receive a RRC reconfiguration request associated with CA. The RRC reconfiguration component 198 may further be configured to perform a first set of RRC reconfiguration operations associated with a first set of physical layer parameters in response to the RRC reconfiguration request. The RRC reconfiguration component 198 may also be configured to transmit, based on completing performing the first set of RRC reconfiguration operations, an RRC reconfiguration complete indication and perform, after transmitting the RRC reconfiguration complete indication, a second set of RRC reconfiguration operations associated with a second set of parameters other than the first set of physical layer parameters. In certain aspects, the RRC reconfiguration component 198 may be configured to receive a RRC reconfiguration request associated with carrier aggregation. The RRC reconfiguration component 198 may further be configured to schedule, in response to the RRC reconfiguration request, at least one gap in uplink transmission and downlink reception via a primary carrier to coincide with one or more time periods based on a known configuration for communication with a network node associated with the carrier aggregation. Although the following description may be focused on 5G NR, the concepts described herein may be applicable to other similar areas, such as LTE, LTE-A, CDMA, GSM, and other wireless technologies.

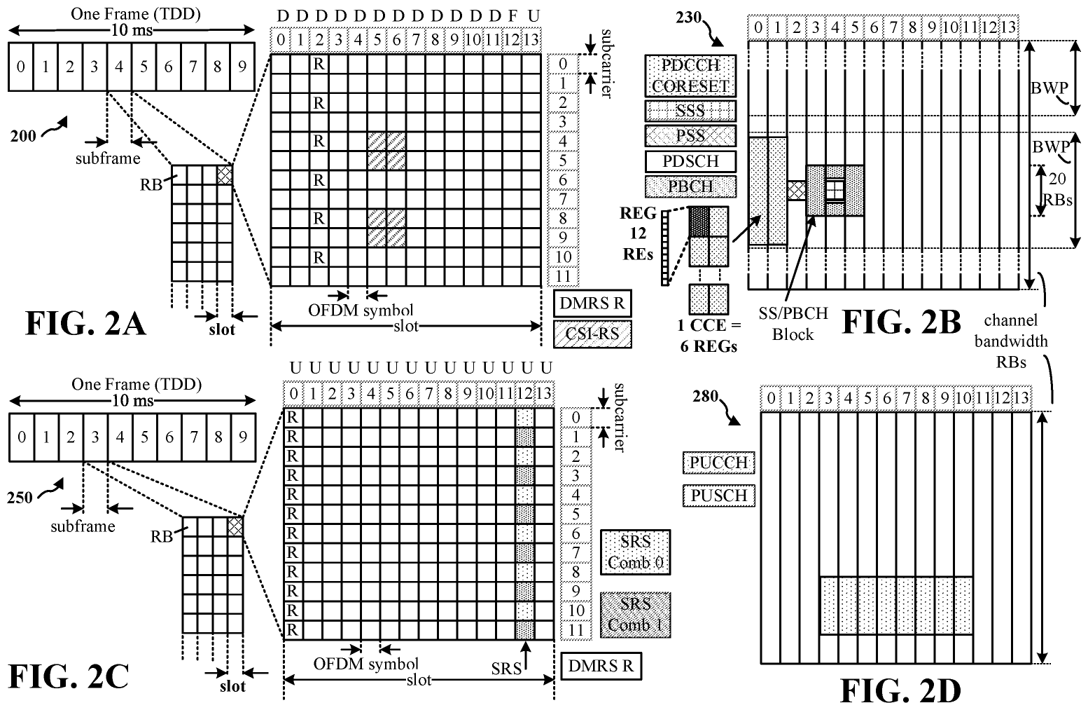

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

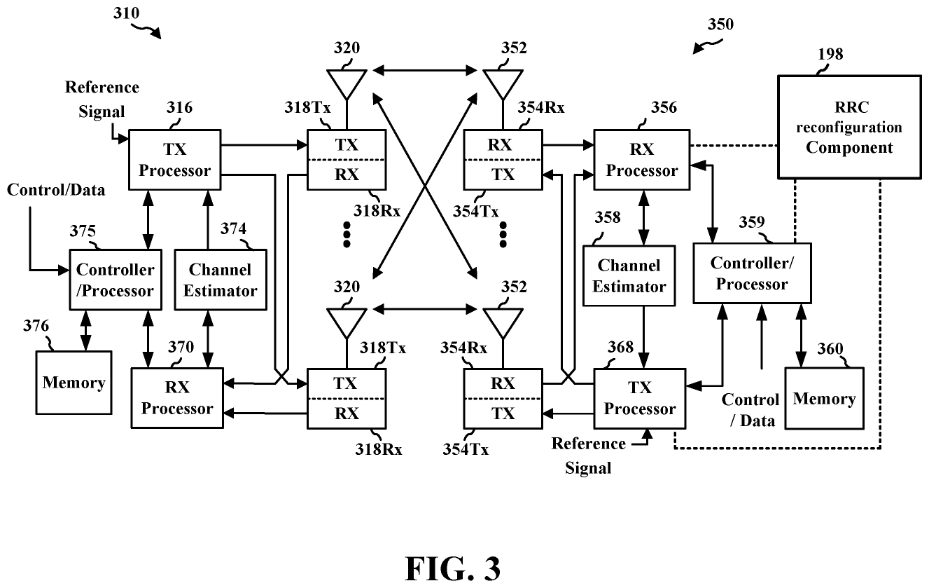

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the RRC reconfiguration component 198 of FIG. 1.

In some aspects of wireless communication, e.g., a RRC reconfiguration operation may be associated with a time limit between a RRC reconfiguration request and a RRC reconfiguration complete. After the time limit, a base station may transmit an activation indication associated with the RRC reconfiguration request. For a RRC reconfiguration request associated with carrier aggregation, the time limit may be shorter than a time for completing radio frequency (RF) tuning. RF tuning operations associated with secondary component carriers (SCC) other than a primary component carrier (PCC) of the carrier aggregation may be associated with interruptions to reception via the primary component carrier. In some aspects, the interruptions may coincide with an activation indication associated with the RRC reconfiguration request such that the activation indication is not received and the RRC reconfiguration may fail (e.g., a SCC associated with the activation indication may not be activated).

Methods and apparatus are provided to reduce the likelihood of failed RRC reconfigurations. For example, a UE may be configured to implement a modified timeline of operations associated with a RRC reconfiguration request. The modified timeline, in some aspects, may be associated with one or more of modified scheduling of operations associated with the RRC reconfiguration request, modified scheduling of a RRC reconfiguration complete transmission, or a modified scheduling of RF blanking (e.g., interruptions to reception via a PCC) for RF tuning operations associated with at least one SCC as will be further described below.

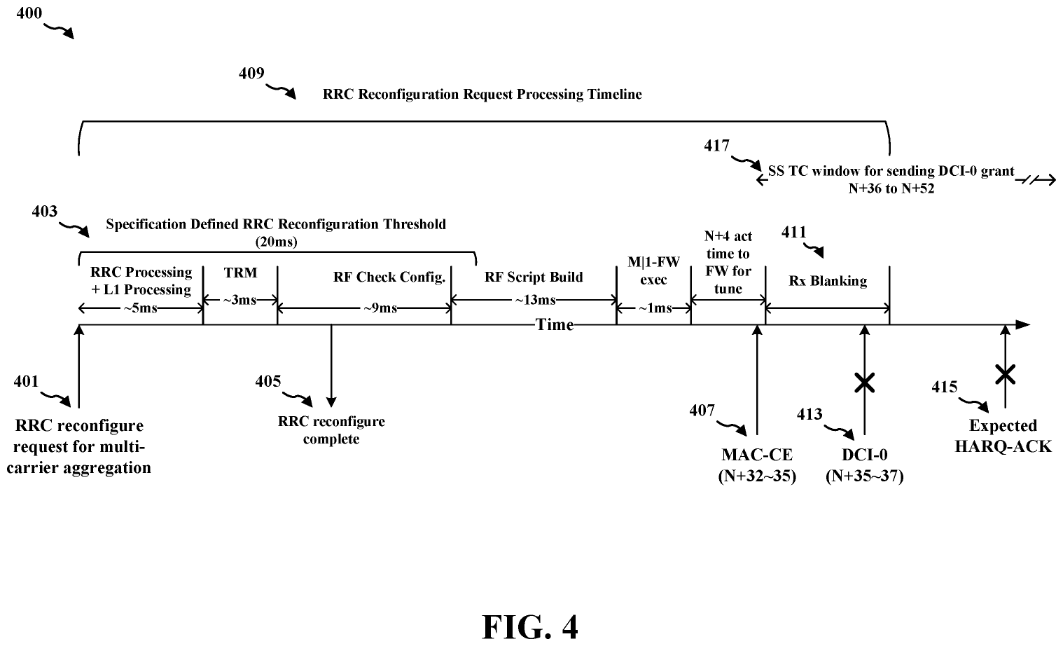

FIG. 4 is a diagram 400 illustrating a timeline for a RRC reconfiguration request 401 associated with a CA in accordance with some aspects of the disclosure. For example, a UE may receive the RRC reconfiguration request 401 from a base station at a first time. The RRC reconfiguration request may be associated with a RRC reconfiguration threshold time 403 (e.g., 20 ms from the RRC reconfiguration request) by which the base station expects a RRC reconfiguration complete indication (e.g., RRC reconfiguration complete indication 405) from the UE. Accordingly, the UE may perform a set of RRC reconfiguration operations based on the RRC reconfiguration request 401. The RRC reconfiguration operations, in some aspects, may include RRC processing and a set of physical layer (e.g., L1) processing or operations and RF tuning operations (e.g., RF check configuration). In some aspects, the RF tuning operations may further include an RF script building operation and a reception (Rx) blanking operation 411 during which reception via a primary component carrier (PCC) associated with the CA may be interrupted to perform RRC reconfiguration operations (e.g., RF tuning operations) for one or more secondary component carriers (SCCs). As indicated, the RRC reconfiguration request processing may span a RRC reconfiguration request processing timeline 409 that extends beyond the RRC reconfiguration threshold time 403.

In response to receiving the RRC reconfiguration complete indication 405, the base station may transmit activation indications associated with the RRC reconfiguration request 401 during a known or configured window based on the timing of the RRC reconfiguration complete indication 405. The activation indications may include a first activation indication transmitted via a MAC-CE 407 and/or a second activation indication transmitted via DCI (e.g., DCI-0 413). As illustrated, one of the activation indications (e.g., DCI-0 413) may be transmitted during the Rx blanking operation 411 causing the UE to not receive the activation indication. Accordingly, the UE may not transmit an acknowledgment (e.g., expected HARQ-ACK 415) and the RRC reconfiguration will fail. In order to avoid having the RRC reconfiguration fail due to Rx blanking (e.g., an interruption to reception via the PCC associated with RF tuning for the one or more SCCs), a method and apparatus are provided to reduce the likelihood of RRC reconfiguration failure.

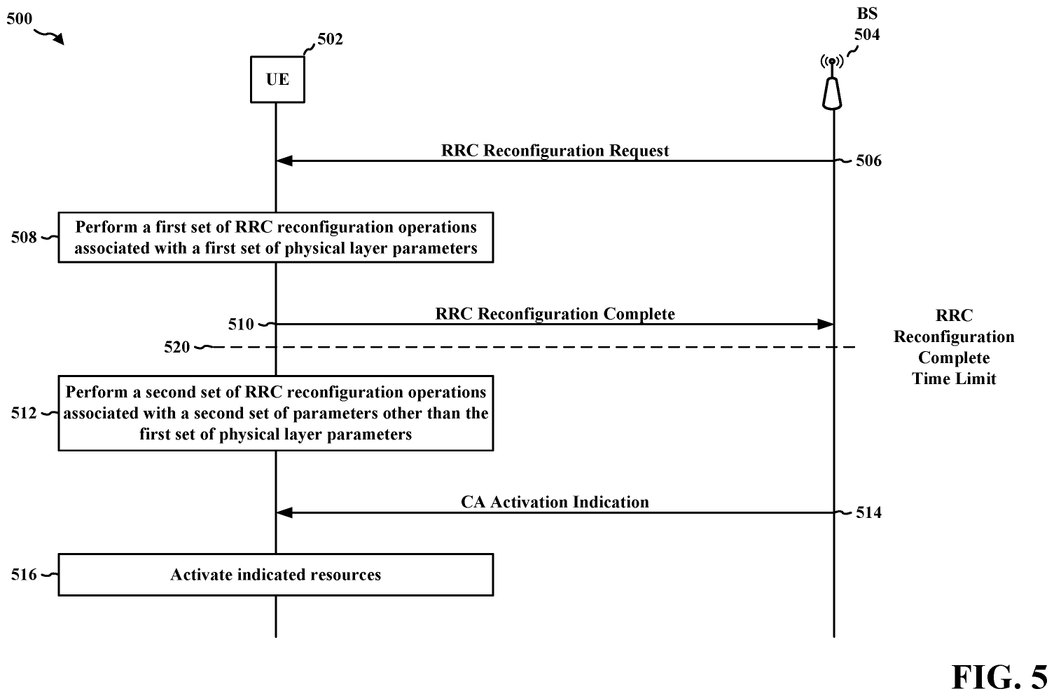

FIG. 5 is a call flow diagram 500 illustrating a first method for wireless communication in accordance with some aspects of the disclosure. A UE 502 may be in communication with a base station 504. The communication may be via a plurality of component carriers including a PCC and one or more SCCs. At a first time, the base station 504 may transmit, and UE 502 may receive, a RRC reconfiguration request 506 associated with the carrier aggregation. As discussed in relation to FIG. 4, the base station 504 may expect a RRC reconfiguration complete indication by a threshold time (e.g., RRC reconfiguration complete time limit 520).

Based on the RRC reconfiguration request 506, the UE 502 may perform, at 508, a first set of RRC reconfiguration operations associated with a first set of physical layer parameters, in response to the RRC reconfiguration request. In some aspects, based on completing the first set of RRC reconfiguration operations performed at 508, the UE 502 may transmit, and the base station 504 may receive, a RRC reconfiguration complete indication 510. The first set of RRC reconfiguration operations associated with the first set of physical layer (e.g., L1) parameters may be a subset of operations performed by a UE before transmitting a RRC reconfiguration complete indication when not using the method of some aspects of the disclosure. In some aspects implementing a method in accordance with the disclosure, by transmitting the RRC reconfiguration complete indication earlier than when not implementing the method, the UE is more likely to receive an activation indication at a time associated with an RRC reconfiguration operation performed for the PCC (e.g., while reception via the PCC is enabled).

After completing the first set of RRC reconfiguration operations, in addition to transmitting the RRC reconfiguration completion indication, the UE 502 may begin a second set of RRC reconfiguration operations associated with a second set of parameters other than the first set of physical layer parameters. The UE 502, in some aspects, may (continue to) perform the second set of RRC reconfiguration operation at 512. In some aspects, the second set of RRC reconfiguration operations may be associated with a set of radio frequency (RF) parameters. The second set of RRC reconfiguration operations, in some aspects, may be associated with the PCC (e.g., the set of radio frequency parameters may be associated with the PCC). The second set of RRC reconfiguration operations, in some aspects, may further include operations associated with parameters (e.g., RF parameters) for one or more SCCs. In some aspects, a set of operations associated with the SCCs may be omitted in order to avoid an interruption to reception via the PCC that might coincide with an activation indication (e.g., CA activation indication 514) associated with the RRC reconfiguration request 506. The CA activation indication 514, in some aspects, may be one of a carrier aggregation activation (e.g., received via a MAC-CE) or a resource grant (e.g., via a DCI-0 grant) associated with the RRC reconfiguration request. In aspects omitting the set of operations associated with the SCCs, the parameters associated with the omitted set of operations may be assumed to be similar, or the same, as previously determined parameters and/or may be determined subsequently.

Based on the CA activation indication 514, the UE 502 may, at 516, activate a set of resources for CA indicated in the CA activation indication 514. The UE, in some aspects, may perform additional RRC reconfiguration operations associated with one or more SCCs before and/or after receiving the CA activation indication 514. The additional RRC reconfiguration operations may be associated with Rx blanking (e.g., an interruption to reception via the PCC), however, as the CA activation indication 514 was already received, the Rx blanking may not lead to the RRC reconfiguration failure illustrated in FIG. 4.

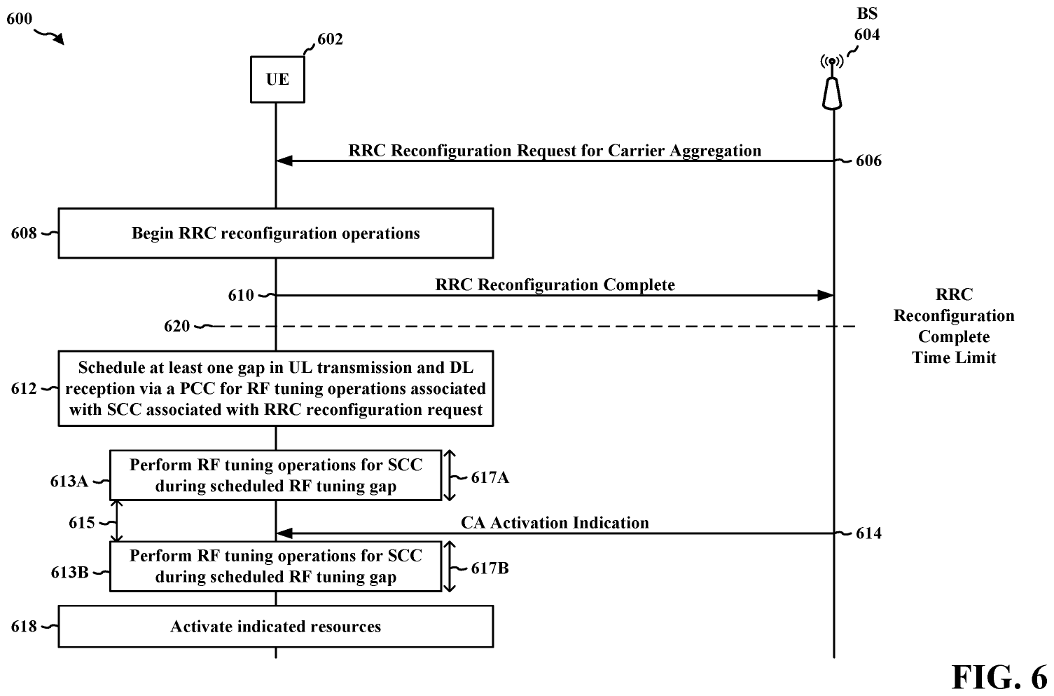

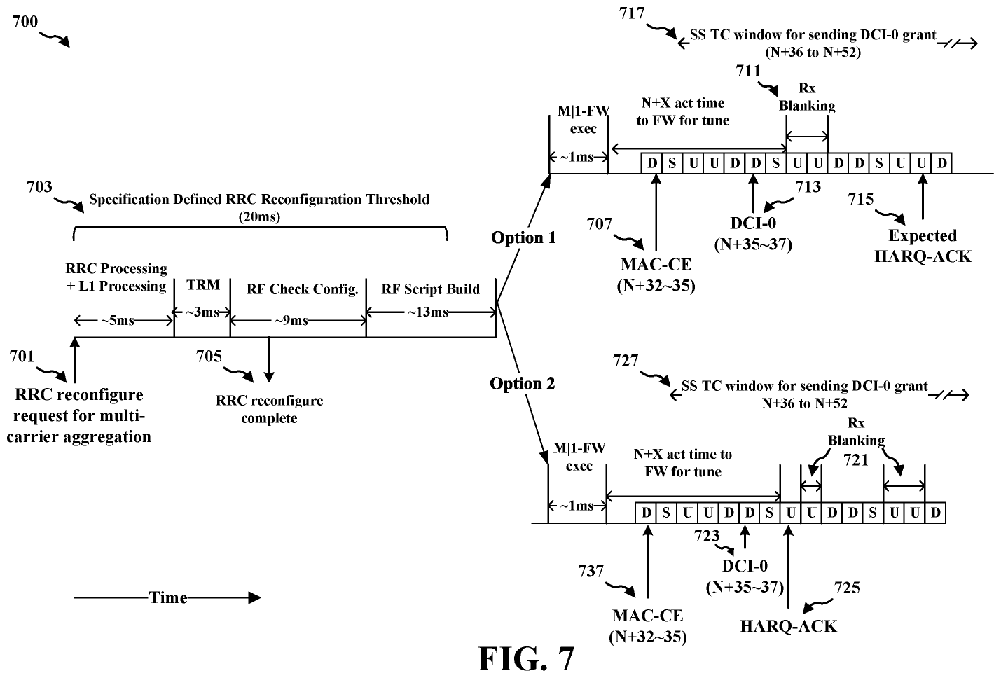

FIG. 6 is a call flow diagram 600 illustrating a second method for wireless communication in accordance with some aspects of the disclosure. FIG. 7 is a diagram 700 illustrating two options associated with implementing the second method described in relation to FIG. 6. A UE 602 may be in communication with a base station 604. The communication may be via a plurality of component carriers including a PCC and one or more SCCs. At a first time, the base station 604 may transmit, and UE 602 may receive, a RRC reconfiguration request 606 associated with the carrier aggregation. For example, the RRC reconfiguration request 606 may correspond to RRC reconfiguration request 701. As discussed in relation to FIG. 4, the base station 604 may expect a RRC reconfiguration complete indication by a threshold time (e.g., RRC reconfiguration complete time limit 620 or RRC reconfiguration threshold time 703).

Based on the RRC reconfiguration request 606, the UE 602 may begin, at 608, a set of RRC reconfiguration operations, in response to the RRC reconfiguration request. In some aspects, based on completing at least a subset of the set of RRC reconfiguration operations begun at 608, the UE 602 may transmit, and the base station 604 may receive, a RRC reconfiguration complete indication 610 corresponding to RRC reconfiguration complete indication 705. The subset of RRC reconfiguration operations completed before transmitting the RRC reconfiguration complete indication 610 may be a first set of RRC reconfiguration operations associated with a first set of parameters corresponding to at least the primary carrier of the carrier aggregation. In some aspects, the first set of parameters may be the first set of physical layer (e.g., L1) parameters as described in relation to FIG. 5. In some aspects, the UE 602 may transmit the RRC reconfiguration complete indication 610 at a time depending on the RRC reconfiguration complete time limit 620. The performance by the UE 602 of the RRC reconfiguration operations begun at 608 and the RRC reconfiguration complete indication 610 transmission may remain unchanged from operations performed by a UE not implementing the method.

After transmitting the RRC reconfiguration complete indication 610, the UE 602 may schedule, at 612, at least one gap (e.g., RF tuning gap 617A and/or RF tuning gap 617B) in uplink transmission and downlink reception via a primary carrier to coincide with one or more time periods based on a known configuration for communication with a network node associated with the carrier aggregation. The one or more time periods coinciding with the at least one scheduled gap, in some aspects, may include at least a first time period avoiding a window associated with receiving at least one of a carrier aggregation activation or a resource grant associated with the RRC reconfiguration request (e.g., time period 417 of FIG. 4 or time period 717 or time period 727 of FIG. 7). The window may begin at a known number of slots, frames, or symbols from the RRC reconfiguration complete indication or, for a resource grant, from a previously-received carrier aggregation activation and may extend for a known number of slots, frames, or symbols. For example, time period 615 may correspond to a window associated with receiving at least one of the carrier aggregation activation or the resource grant associated with the RRC reconfiguration request and RF tuning gap 617A and/or 617B (e.g., Rx blanking for RF tuning operations associated with one or more SCCs) may be scheduled to avoid the time period 615. The carrier aggregation activation and the resource grant, in some aspects, are associated with separate windows that are each avoided when scheduling

In some aspects, the known configuration may be associated with a time division duplex (TDD) format specifying subframes as one of DL resources, UL resources, guard band resources (e.g., unused resources to separate between DL and UL resources), or variable resources (either DL or UL). The scheduled gaps (e.g., Rx blanking 711 or Rx blanking 721) may be scheduled to occur during UL resources so as to avoid missing an activation indication and/or a resource grant. For example, FIG. 6 illustrates that a CA activation indication 614 may be received during a time period 615 before and/or after scheduled RF tuning gaps 617A and 617B. In such aspects, the time period may correspond to a DL resource of the TDD format.

In some aspects, as illustrated in a first implementation (“option 1”) of FIG. 7, the UE (e.g., the UE 602) may consider the configuration of the subframe (e.g., whether it is specified as an UL resource or a DL resource) when scheduling the Rx blanking 711 associated with RRC reconfiguration operations (e.g., RF tuning operations) associated with at least one SCC. In option 1, at least one UL resource is selected and/or configured to be used for the Rx blanking 711 associated with the RF tuning operations for one or more SCCs. A selected UL resource in some aspects, may be associated with a data transmission (e.g., a feedback such as HARQ-ACK 715) that may be preempted by the Rx blanking. Accordingly, in some aspects, as illustrated in a second implementation (“option 2”) of FIG. 7, a UE (e.g., the UE 602) may further consider whether data (e.g., feedback such as HARQ-ACK 725) is scheduled for transmission via a particular UL resource when scheduling or implementing Rx blanking. For example, the UE, may not select (or may cancel a previous selection of) one or more UL resources associated with a scheduled UL transmission (e.g., HARQ-ACK 725) when scheduling the Rx blanking 721. Accordingly, by scheduling Rx blanking and/or RF tuning operations associated with one or more SCCs during UL resources, the UE may ensure, or at least make it more likely, that activation indications (e.g., MAC-CE 707 and MAC-CE 737) and/or resource grants (e.g., DCI-0 713 and DCI-0 723) are received and the RRC reconfiguration does not fail due to the Rx blanking 711 and/or 721. The UE 502, in some aspects, may, at 613A and/or at 613B, perform RF tuning operations for the one or more SCCs during the scheduled RF tuning gaps 617A and/or 617B, respectively.

The methods described in relation to FIGS. 5 and 6, in some aspects, may be used by a same UE (e.g., UE 502 or UE 602) in association with a same RRC reconfiguration request where performing the method described in relation to FIG. 5 may be used to shorten the time to transmit the RRC reconfiguration complete indication (e.g., RRC reconfiguration complete indication 510, 610, or 705) and/or increase the likelihood of the carrier aggregation activation and/or the resource grant (e.g., CA activation indication 514 or 614, MAC-CE 707 or 737, or DCI-0 713 or 723) being received while performing operations associated with the PCC. Accordingly, scheduling the RF tuning gap 617A or 617B or the Rx blanking 711, 721 to avoid a reception of the carrier aggregation activation and/or the resource grant (e.g., CA activation indication 514 or 614, MAC-CE 707 or 737, or DCI-0 713 or 723) may be avoided for occasions for which the carrier aggregation activation and/or the resource grant was already received.

Based on the CA activation indication 614, the UE 602 may activate, at 618, a set of resources for CA indicated in the CA activation indication 614. The UE, in some aspects, may perform additional RRC reconfiguration operations associated with one or more SCCs before and/or after receiving the CA activation indication 614. The additional RRC reconfiguration operations may be associated with Rx blanking (e.g., an interruption to reception via the PCC), however, as the CA activation indication 614 was already received, the Rx blanking may not lead to RRC reconfiguration failure as illustrated in FIG. 4.

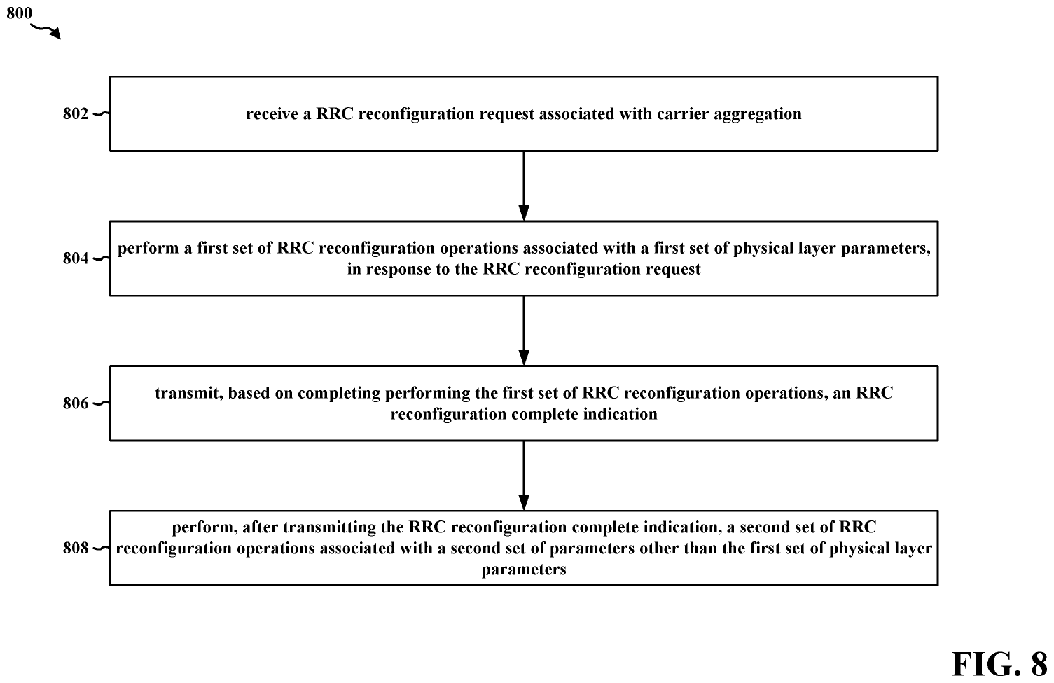

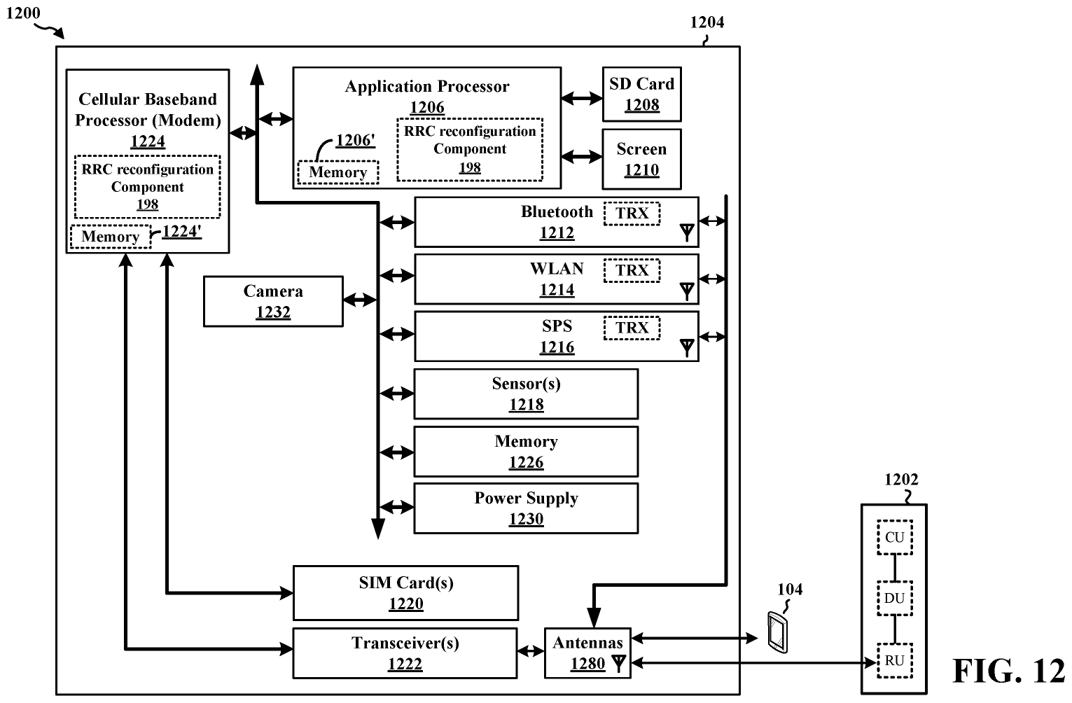

FIG. 8 is a flowchart 800 of a method of wireless communication. The method may be performed by a UE (e.g., the UE 104, 502, and 602; the apparatus 1204). At 802, the UE may receive a RRC reconfiguration request associated with carrier aggregation. For example, 802 may be performed by application processor 1206, cellular baseband processor 1224, transceiver(s) 1222, antenna(s) 1280, and/or RRC reconfiguration component 198 of FIG. 12. The carrier aggregation, in some aspects, may be associated with a PCC and one or more SCCs. The RRC reconfiguration request, in some aspects, may be associated with a threshold time for receiving an RRC reconfiguration complete indication from the UE (e.g., an indication that the UE has completed operations associated with the RRC reconfiguration request). For example, referring to FIGS. 5 and 6, the UE 502 or 602, may receive, and base station 504 or 604 may transmit, RRC reconfiguration request 506 or 606.

At 804, the UE may perform a first set of RRC reconfiguration operations associated with a first set of physical layer parameters in response to the RRC reconfiguration request. For example, 804 may be performed by application processor 1206, cellular baseband processor 1224, transceiver(s) 1222, antenna(s) 1280, and/or RRC reconfiguration component 198 of FIG. 12. The first set of RRC reconfiguration operations associated with the first set of physical layer (e.g., L1) parameters may be a subset of operations performed by a UE before transmitting a RRC reconfiguration complete indication when not using the method of some aspects of the disclosure. In some aspects, the first set of RRC reconfiguration operations (and the first set of physical layer parameters) may be a minimal set of operations (or physical layer parameters) for transmitting the RRC reconfiguration complete indication and proceeding with the RRC reconfiguration process. For example, referring to FIG. 5, the UE 502 may perform, at 508, a first set of RRC reconfiguration operations associated with a first set of physical layer parameters in response to the RRC reconfiguration request.

At 806, the UE may transmit, based on completing performing the first set of RRC reconfiguration operations, an RRC reconfiguration complete indication. For example, 806 may be performed by application processor 1206, cellular baseband processor 1224, transceiver(s) 1222, antenna(s) 1280, and/or RRC reconfiguration component 198 of FIG. 12. As discussed above, the RRC reconfiguration complete indication, in some aspects, may be transmitted at 806 earlier in the RRC reconfiguration process (e.g., after fewer RRC reconfiguration operations performed by the UE) than it would be transmitted by a UE not implementing the method. In some aspects, transmitting the RRC reconfiguration complete indication is further based on a timer beginning at the receiving of the RRC reconfiguration request associated with the carrier aggregation and occurs before the timer reaches a known threshold time. For example, referring to FIG. 5, the UE 502 may, based on completing the first set of RRC reconfiguration operations performed at 508, transmit RRC reconfiguration complete indication 510 before a RRC reconfiguration complete time limit 520.

At 808, the UE may perform, after transmitting the RRC reconfiguration complete indication, a second set of RRC reconfiguration operations associated with a second set of parameters other than the first set of physical layer parameters. For example, 808 may be performed by application processor 1206, cellular baseband processor 1224, transceiver(s) 1222, antenna(s) 1280, and/or RRC reconfiguration component 198 of FIG. 12. In some aspects, the second set of parameters include a set of RF parameters. The second set of RRC reconfiguration operations, in some aspects, may be associated with the PCC of the carrier aggregation. In some aspects, the second set of RRC reconfiguration operations may be associated with a continuous period of at least one of reception or transmission via the primary carrier (e.g., a period without any Rx blanking on the PCC) for completing the RRC reconfiguration procedure associated with the RRC reconfiguration request. In some aspects, the second set of RRC reconfiguration operations may further include operations associated with the one or more SCCs. For example, referring to FIG. 5, the UE 502 may perform the second set of RRC reconfiguration operation at 512 after transmitting the RRC reconfiguration complete indication 510.

In some aspects, the UE may omit a set of RF tuning operations associated with non-primary carriers (e.g., SCCs) for the RRC reconfiguration procedure. In some aspects, the set of RF tuning operations may include operations associated with an inability to receive a transmission via the PCC. The set of RF tuning operations may be associated with Rx blanking for the PCC while the UE receives transmissions via one or more of the SCCs. Accordingly, the RF tuning operations associated with the non-primary carriers may be omitted to ensure that a carrier aggregation activation or a resource grant associated with the RRC reconfiguration request may be received (e.g., via a MAC-CE or DCI) over the PCC. For example, referring to FIGS. 5 and 6, the UE 502, may omit RF tuning operations such as the RF tuning operations for the one or more SCCs performed at 613A and/or 613B associated with a SCC.

The UE may receive, at a time based on transmitting the RRC reconfiguration complete indication, at least one of a MAC-CE or DCI associated with the RRC reconfiguration request. The MAC-CE, in some aspects, may be associated with a carrier aggregation activation for the RRC reconfiguration request. Similarly, the DCI may be associated with a resource grant for the RRC reconfiguration request. Referring to FIG. 5, for example, the UE 502 may receive CA activation indication 514 based on RRC reconfiguration complete indication 510. The UE may then activate resources indicated by the MAC-CE or DCI for the carrier aggregation.

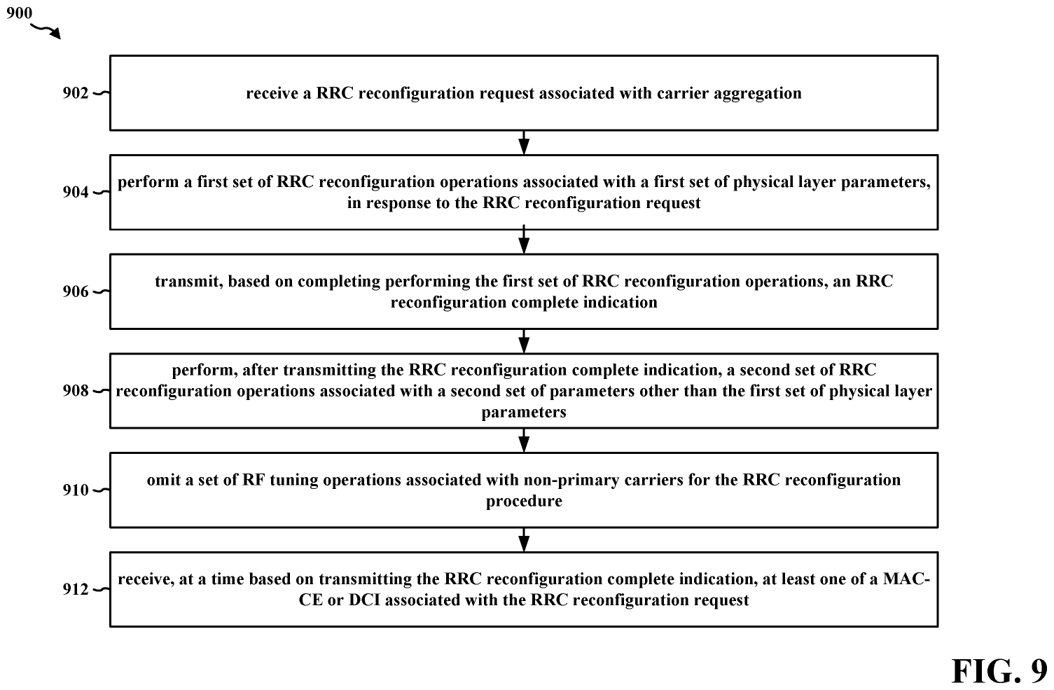

FIG. 9 is a flowchart 900 of a method of wireless communication. The method may be performed by a UE (e.g., the UE 104, 502, and 602; the apparatus 1204). At 902, the UE may receive a RRC reconfiguration request associated with carrier aggregation. For example, 902 may be performed by application processor 1206, cellular baseband processor 1224, transceiver(s) 1222, antenna(s) 1280, and/or RRC reconfiguration component 198 of FIG. 12. The carrier aggregation, in some aspects, may be associated with a PCC and one or more SCCs. The RRC reconfiguration request, in some aspects, may be associated with a threshold time for receiving an RRC reconfiguration complete indication from the UE (e.g., an indication that the UE has completed operations associated with the RRC reconfiguration request). For example, referring to FIGS. 5 and 6, the UE 502 or 602, may receive, and base station 504 or 604 may transmit, RRC reconfiguration request 506 or 606.

At 904, the UE may perform a first set of RRC reconfiguration operations associated with a first set of physical layer parameters in response to the RRC reconfiguration request. For example, 904 may be performed by application processor 1206, cellular baseband processor 1224, transceiver(s) 1222, antenna(s) 1280, and/or RRC reconfiguration component 198 of FIG. 12. The first set of RRC reconfiguration operations associated with the first set of physical layer (e.g., L1) parameters may be a subset of operations performed by a UE before transmitting a RRC reconfiguration complete indication when not using the method of some aspects of the disclosure. In some aspects, the first set of RRC reconfiguration operations (and the first set of physical layer parameters) may be a minimal set of operations (or physical layer parameters) for transmitting the RRC reconfiguration complete indication and proceeding with the RRC reconfiguration process. For example, referring to FIG. 5, the UE 502 may perform, at 508, a first set of RRC reconfiguration operations associated with a first set of physical layer parameters in response to the RRC reconfiguration request.

At 906, the UE may transmit, based on completing performing the first set of RRC reconfiguration operations, an RRC reconfiguration complete indication. For example, 906 may be performed by application processor 1206, cellular baseband processor 1224, transceiver(s) 1222, antenna(s) 1280, and/or RRC reconfiguration component 198 of FIG. 12. As discussed above, the RRC reconfiguration complete indication, in some aspects, may be transmitted at 906 earlier in the RRC reconfiguration process (e.g., after fewer RRC reconfiguration operations performed by the UE) than it would be transmitted by a UE not implementing the method. In some aspects, transmitting the RRC reconfiguration complete indication is further based on a timer beginning at the receiving of the RRC reconfiguration request associated with the carrier aggregation and occurs before the timer reaches a known threshold time. For example, referring to FIG. 5, the UE 502 may, based on completing the first set of RRC reconfiguration operations performed at 508, transmit RRC reconfiguration complete indication 510 before a RRC reconfiguration complete time limit 520.

At 908, the UE may perform, after transmitting the RRC reconfiguration complete indication, a second set of RRC reconfiguration operations associated with a second set of parameters other than the first set of physical layer parameters. For example, 908 may be performed by application processor 1206, cellular baseband processor 1224, transceiver(s) 1222, antenna(s) 1280, and/or RRC reconfiguration component 198 of FIG. 12. In some aspects, the second set of parameters include a set of RF parameters. The second set of RRC reconfiguration operations, in some aspects, may be associated with the PCC of the carrier aggregation. In some aspects, the second set of RRC reconfiguration operations may be associated with a continuous period of at least one of reception or transmission via the primary carrier (e.g., a period without any Rx blanking on the PCC) for completing the RRC reconfiguration procedure associated with the RRC reconfiguration request. In some aspects, the second set of RRC reconfiguration operations may further include operations associated with the one or more SCCs. For example, referring to FIG. 5, the UE 502 may perform the second set of RRC reconfiguration operation at 512 after transmitting the RRC reconfiguration complete indication 510.

At 910, the UE may omit a set of RF tuning operations associated with non-primary carriers (e.g., SCCs) for the RRC reconfiguration procedure. For example, 910 may be performed by application processor 1206 and/or RRC reconfiguration component 198 of FIG. 12. In some aspects, the set of RF tuning operations may include operations associated with an inability to receive a transmission via the PCC. The set of RF tuning operations may be associated with Rx blanking for the PCC while the UE receives transmissions via one or more of the SCCs. Accordingly, the RF tuning operations associated with the non-primary carriers may be omitted to ensure that a carrier aggregation activation or a resource grant associated with the RRC reconfiguration request may be received (e.g., via a MAC-CE or DCI) over the PCC. For example, referring to FIGS. 5 and 6, the UE 502, may omit RF tuning operations such as the RF tuning operations for the one or more SCCs performed at 613A and/or 613B associated with a SCC.

Finally, at 912, the UE may receive, at a time based on transmitting the RRC reconfiguration complete indication, at least one of a MAC-CE or DCI associated with the RRC reconfiguration request. For example, 912 may be performed by application processor 1206 and/or RRC reconfiguration component 198 of FIG. 12. The MAC-CE, in some aspects, may be associated with a carrier aggregation activation for the RRC reconfiguration request. Similarly, the DCI may be associated with a resource grant for the RRC reconfiguration request. Referring to FIG. 5, for example, the UE 502 may receive CA activation indication 514 based on RRC reconfiguration complete indication 510. The UE may then activate resources indicated by the MAC-CE or DCI for the carrier aggregation.

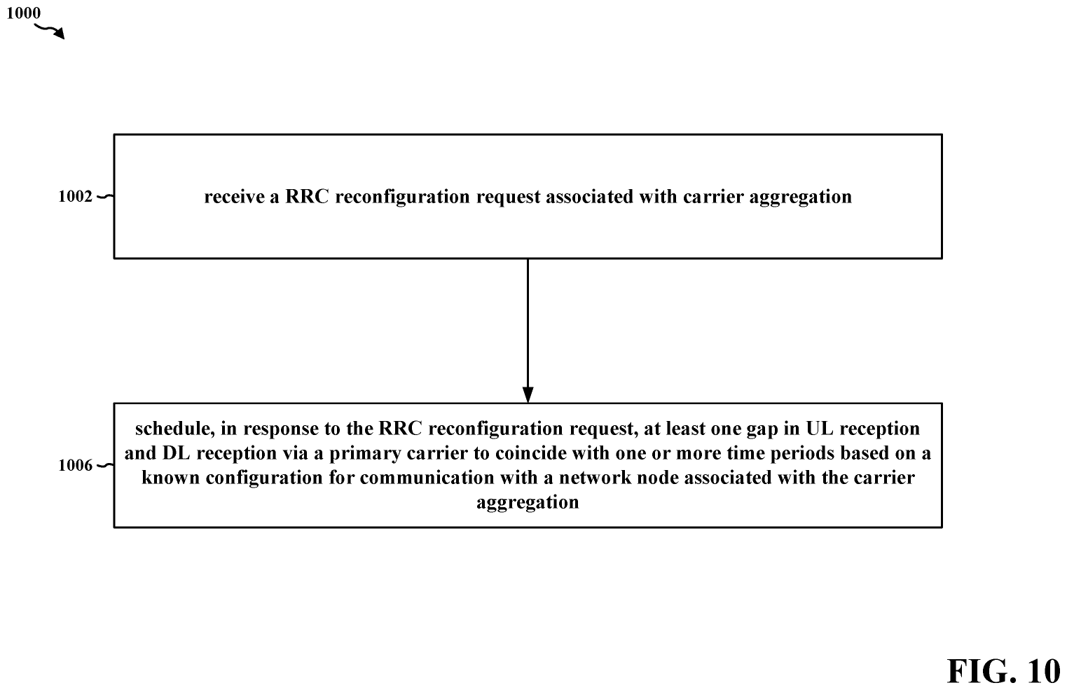

FIG. 10 is a flowchart 1000 of a method of wireless communication. The method may be performed by a UE (e.g., the UE 104, 502, and 602; the apparatus 1204). At 1002, the UE may receive a RRC reconfiguration request associated with carrier aggregation. For example, 1002 may be performed by application processor 1206, cellular baseband processor 1224, transceiver(s) 1222, antenna(s) 1280, and/or RRC reconfiguration component 198 of FIG. 12. The carrier aggregation, in some aspects, may be associated with a PCC and one or more SCCs. The RRC reconfiguration request, in some aspects, may be associated with a threshold time for receiving an RRC reconfiguration complete indication from the UE (e.g., an indication that the UE has completed operations associated with the RRC reconfiguration request). For example, referring to FIG. 6, the UE 602, may receive, and base station 604 may transmit, RRC reconfiguration request 606.

Based on receiving the RRC reconfiguration request, the UE may perform a first set of RRC reconfiguration operations associated with a first set of parameters corresponding to at least the primary carrier of the carrier aggregation. In some aspects, the first set of RRC reconfiguration operations may correspond to a set of physical layer parameters for the PCC. Based on completing the first set of RRC reconfiguration operations, the UE, in some aspects, may transmit a RRC reconfiguration complete indication. For example, referring to FIG. 6, the UE 602 may begin performing a set of RRC reconfiguration operations at 608 and may transmit RRC reconfiguration complete indication 610 after the completion of a subset of the RRC reconfiguration operations (e.g., corresponding to the first set RRC reconfiguration operations associated with the first set of parameters).

At 1006, the UE may schedule, in response to the RRC reconfiguration request, at least one gap in UL transmission and DL reception via the PCC to coincide with one or more time periods based on a known configuration for communication with a network node associated with the carrier aggregation. For example, 1006 may be performed by application processor 1206 and/or RRC reconfiguration component 198 of FIG. 12. In some aspects, the scheduling may further be based on performing the first set of RRC reconfiguration operations (and transmitting the RRC reconfiguration complete indication). The one or more time periods coinciding with the at least one scheduled gap, in some aspects, may include at least a first time period avoiding a window associated with receiving at least one of a carrier aggregation activation or a resource grant associated with the RRC reconfiguration request (e.g., time period 417 of FIG. 4 or time period 717 or time period 727 of FIG. 7). The window may begin at a known number of slots, frames, or symbols from the RRC reconfiguration complete indication or, for a resource grant, from a previously-received carrier aggregation activation and may extend for a known number of slots, frames, or symbols. For example, referring to FIG. 6, the UE 602 may schedule, at 612, at least one gap (e.g., RF tuning gap 617A and/or RF tuning gap 617B) in UL transmission and DL reception via a PCC to coincide with one or more time periods based on a known configuration for communication with a network node associated with the carrier aggregation. In some aspects, time period 615 may correspond to a window associated with receiving at least one of the carrier aggregation activation or the resource grant associated with the RRC reconfiguration request and RF tuning gap 617A and/or 617B (e.g., Rx blanking for RF tuning operations associated with one or more SCCs) may be scheduled to avoid the time period 615. The carrier aggregation activation and the resource grant, in some aspects, are associated with separate windows that are each avoided when scheduling

In some aspects, the known configuration may be associated with a time division duplex (TDD) format specifying subframes as one of DL resources, UL resources, guard band resources (e.g., unused resources to separate between DL and UL resources), or variable resources (either DL or UL). The scheduled gaps (e.g., Rx blanking 711 or Rx blanking 721) may be scheduled to occur during UL resources so as to avoid missing an activation indication and/or a resource grant. Accordingly, the at least one time period may include one or more UL subframes of a TDD configuration and/or format. For example, referring to FIG. 6, the UE 602 may schedule the gaps in UL transmission and DL reception around time period 615 and may receive the CA activation indication 614 during the time period 615 before and/or after scheduled RF tuning gaps 617A and 617B. In such aspects, the time period may correspond to a DL resource of the TDD format.

In some aspects, as illustrated in a first implementation (“option 1”) of FIG. 7, the UE (e.g., the UE 602) may consider the configuration of the subframe (e.g., whether it is specified as an UL resource or a DL resource) when scheduling the Rx blanking 711 associated with RRC reconfiguration operations (e.g., RF tuning operations) associated with at least one SCC. In option 1, at least one UL resource is selected and/or configured to be used for the Rx blanking 711 associated with the RF tuning operations for one or more SCCs. In some aspects, as illustrated in a second implementation (“option 2”) of FIG. 7, a UE (e.g., the UE 602) may further consider whether data (e.g., feedback such as HARQ-ACK 725) is scheduled for transmission via a particular UL resource when scheduling or implementing Rx blanking. In some aspects, the one or more UL subframes includes UL subframes that are not associated with a feedback transmission. For example, the UE, may not select (or may cancel a previous selection of) one or more UL resources associated with a scheduled UL transmission (e.g., HARQ-ACK 725) when scheduling the Rx blanking 721.

Accordingly, by scheduling Rx blanking and/or RF tuning operations associated with one or more SCCs during UL resources, the UE may ensure, or at least make it more likely, that activation indications (e.g., MAC-CE 707 and MAC-CE 737) and/or resource grants (e.g., DCI-0 713 and DCI-0 723) are received and the RRC reconfiguration does not fail due to the Rx blanking 711 and/or 721. The UE 502, in some aspects, may, at 613A and/or at 613B, perform RF tuning operations for the one or more SCCs during the scheduled RF tuning gaps 617A and/or 617B, respectively.

The UE may perform, during the at least one gap in the uplink transmission and the downlink reception via the primary carrier, a second set of RRC reconfiguration operations associated with a second set of parameters corresponding to at least one non-primary carrier of the carrier aggregation. For example, 1008 may be performed by application processor 1206, cellular baseband processor 1224, transceiver(s) 1222, antenna(s) 1280, and/or RRC reconfiguration component 198 of FIG. 12. In some aspects, the second set of RRC reconfiguration operations includes a set of RF tuning operations associated with the at least one non-primary carrier (e.g., a SCC).

The UE may receive, at a time based on transmitting the RRC reconfiguration complete indication, at least one of a MAC-CE or DCI associated with the RRC reconfiguration request. The MAC-CE, in some aspects, may be associated with a carrier aggregation activation for the RRC reconfiguration request. Similarly, the DCI may be associated with a resource grant for the RRC reconfiguration request. Referring to FIG. 6, for example, the UE 602 may receive CA activation indication 614 based on RRC reconfiguration complete indication 610. The UE may then activate, at 616, resources indicated by the MAC-CE or DCI for the carrier aggregation.

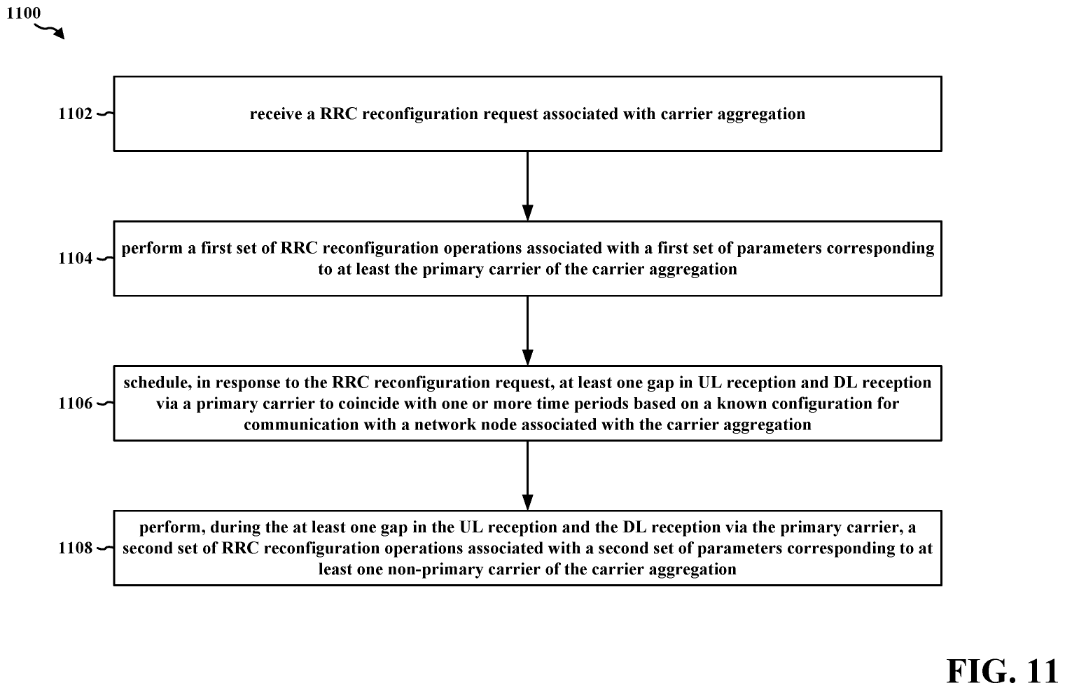

FIG. 11 is a flowchart 1100 of a method of wireless communication. The method may be performed by a UE (e.g., the UE 104, 502, and 602; the apparatus 1204). At 1102, the UE may receive a RRC reconfiguration request associated with carrier aggregation. For example, 1102 may be performed by application processor 1206, cellular baseband processor 1224, transceiver(s) 1222, antenna(s) 1280, and/or RRC reconfiguration component 198 of FIG. 12. The carrier aggregation, in some aspects, may be associated with a PCC and one or more SCCs. The RRC reconfiguration request, in some aspects, may be associated with a threshold time for receiving an RRC reconfiguration complete indication from the UE (e.g., an indication that the UE has completed operations associated with the RRC reconfiguration request). For example, referring to FIGS. 5 and 6, the UE 502 or 602, may receive, and base station 504 or 604 may transmit, RRC reconfiguration request 506 or 606.

At 1104, the UE may perform a first set of RRC reconfiguration operations associated with a first set of parameters corresponding to at least the primary carrier of the carrier aggregation. For example, 1104 may be performed by application processor 1206, cellular baseband processor 1224, transceiver(s) 1222, antenna(s) 1280, and/or RRC reconfiguration component 198 of FIG. 12. In some aspects, the first set of RRC reconfiguration operations may correspond to a set of physical layer parameters for the PCC. Based on completing the first set of RRC reconfiguration operations, the UE, in some aspects, may transmit a RRC reconfiguration complete indication. For example, referring to FIG. 6, the UE 602 may begin performing a set of RRC reconfiguration operations at 608 and may transmit RRC reconfiguration complete indication 610 after the completion of a subset of the RRC reconfiguration operations (e.g., corresponding to the first set RRC reconfiguration operations associated with the first set of parameters).

At 1106, the UE may schedule, in response to the RRC reconfiguration request, at least one gap in UL transmission and DL reception via the PCC to coincide with one or more time periods based on a known configuration for communication with a network node associated with the carrier aggregation. For example, 1106 may be performed by application processor 1206 and/or RRC reconfiguration component 198 of FIG. 12. In some aspects, the scheduling may further be based on performing, at 1104, the first set of RRC reconfiguration operations (and transmitting the RRC reconfiguration complete indication). The one or more time periods coinciding with the at least one scheduled gap, in some aspects, may include at least a first time period avoiding a window associated with receiving at least one of a carrier aggregation activation or a resource grant associated with the RRC reconfiguration request (e.g., time period 417 of FIG. 4 or time period 717 or time period 727 of FIG. 7). The window may begin at a known number of slots, frames, or symbols from the RRC reconfiguration complete indication or, for a resource grant, from a previously-received carrier aggregation activation and may extend for a known number of slots, frames, or symbols. For example, referring to FIG. 6, the UE 602 may schedule, at 612, at least one gap (e.g., RF tuning gap 617A and/or RF tuning gap 617B) in UL transmission and DL reception via a PCC to coincide with one or more time periods based on a known configuration for communication with a network node associated with the carrier aggregation. In some aspects, time period 615 may correspond to a window associated with receiving at least one of the carrier aggregation activation or the resource grant associated with the RRC reconfiguration request and RF tuning gap 617A and/or 617B (e.g., Rx blanking for RF tuning operations associated with one or more SCCs) may be scheduled to avoid the time period 615. The carrier aggregation activation and the resource grant, in some aspects, are associated with separate windows that are each avoided when scheduling

In some aspects, the known configuration may be associated with a time division duplex (TDD) format specifying subframes as one of DL resources, UL resources, guard band resources (e.g., unused resources to separate between DL and UL resources), or variable resources (either DL or UL). The scheduled gaps (e.g., Rx blanking 711 or Rx blanking 721) may be scheduled to occur during UL resources so as to avoid missing an activation indication and/or a resource grant. Accordingly, the at least one time period may include one or more UL subframes of a TDD configuration and/or format. For example, referring to FIG. 6, the UE 602 may schedule the gaps in UL transmission and DL reception around time period 615 and may receive the CA activation indication 614 during the time period 615 before and/or after scheduled RF tuning gaps 617A and 617B. In such aspects, the time period may correspond to a DL resource of the TDD format.

In some aspects, as illustrated in a first implementation (“option 1”) of FIG. 7, the UE (e.g., the UE 602) may consider the configuration of the subframe (e.g., whether it is specified as an UL resource or a DL resource) when scheduling the Rx blanking 711 associated with RRC reconfiguration operations (e.g., RF tuning operations) associated with at least one SCC. In option 1, at least one UL resource is selected and/or configured to be used for the Rx blanking 711 associated with the RF tuning operations for one or more SCCs. In some aspects, as illustrated in a second implementation (“option 2”) of FIG. 7, a UE (e.g., the UE 602) may further consider whether data (e.g., feedback such as HARQ-ACK 725) is scheduled for transmission via a particular UL resource when scheduling or implementing Rx blanking. In some aspects, the one or more UL subframes includes UL subframes that are not associated with a feedback transmission. For example, the UE, may not select (or may cancel a previous selection of) one or more UL resources associated with a scheduled UL transmission (e.g., HARQ-ACK 725) when scheduling the Rx blanking 721.

Accordingly, by scheduling Rx blanking and/or RF tuning operations associated with one or more SCCs during UL resources, the UE may ensure, or at least make it more likely, that activation indications (e.g., MAC-CE 707 and MAC-CE 737) and/or resource grants (e.g., DCI-0 713 and DCI-0 723) are received and the RRC reconfiguration does not fail due to the Rx blanking 711 and/or 721. The UE 502, in some aspects, may, at 613A and/or at 613B, perform RF tuning operations for the one or more SCCs during the scheduled RF tuning gaps 617A and/or 617B, respectively.

Finally, at 1108, the UE may perform, during the at least one gap in the uplink transmission and the downlink reception via the primary carrier, a second set of RRC reconfiguration operations associated with a second set of parameters corresponding to at least one non-primary carrier of the carrier aggregation. For example, 1108 may be performed by application processor 1206, cellular baseband processor 1224, transceiver(s) 1222, antenna(s) 1280, and/or RRC reconfiguration component 198 of FIG. 12. In some aspects, the second set of RRC reconfiguration operations includes a set of RF tuning operations associated with the at least one non-primary carrier (e.g., a SCC).

The UE may receive, at a time based on transmitting the RRC reconfiguration complete indication, at least one of a MAC-CE or DCI associated with the RRC reconfiguration request. The MAC-CE, in some aspects, may be associated with a carrier aggregation activation for the RRC reconfiguration request. Similarly, the DCI may be associated with a resource grant for the RRC reconfiguration request. Referring to FIG. 6, for example, the UE 602 may receive CA activation indication 614 based on RRC reconfiguration complete indication 610. The UE may then activate, at 616, resources indicated by the MAC-CE or DCI for the carrier aggregation.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the TX processor 368, the RX processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see 350 of FIG. 3) and include the additional modules of the apparatus 1204.

As discussed supra, the RRC reconfiguration component 198 is configured to receive a RRC reconfiguration request associated with CA; perform a first set of RRC reconfiguration operations associated with a first set of physical layer parameters in response to the RRC reconfiguration request; transmit, based on completing performing the first set of RRC reconfiguration operations, an RRC reconfiguration complete indication; and perform, after transmitting the RRC reconfiguration complete indication, a second set of RRC reconfiguration operations associated with a second set of parameters other than the first set of physical layer parameters. In certain aspects, the RRC reconfiguration component 198 may be configured to receive a RRC reconfiguration request associated with carrier aggregation and schedule, in response to the RRC reconfiguration request, at least one gap in uplink transmission and downlink reception via a primary carrier to coincide with one or more time periods based on a known configuration for communication with a network node associated with the carrier aggregation. The RRC reconfiguration component 198 may be within the cellular baseband processor 1224, the application processor 1206, or both the cellular baseband processor 1224 and the application processor 1206. The RRC reconfiguration component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, includes means for receiving a RRC reconfiguration request associated with carrier aggregation. The apparatus 1204, and in particular the cellular baseband processor 1224 and/or the application processor 1206, may include means for performing a first set of RRC reconfiguration operations associated with a first set of physical layer parameters, in response to the RRC reconfiguration request. The apparatus 1204, and in particular the cellular baseband processor 1224 and/or the application processor 1206, may include means for transmitting, based on completing performing the first set of RRC reconfiguration operations, an RRC reconfiguration complete indication. The apparatus 1204, and in particular the cellular baseband processor 1224 and/or the application processor 1206, may include means for performing, after transmitting the RRC reconfiguration complete indication, a second set of RRC reconfiguration operations associated with a second set of parameters other than the first set of physical layer parameters. The apparatus 1204, and in particular the cellular baseband processor 1224 and/or the application processor 1206, may include means for omitting a set of RF tuning operations associated with non-primary carriers for the RRC reconfiguration procedure. The apparatus 1204, and in particular the cellular baseband processor 1224 and/or the application processor 1206, may include means for receiving, at a time based on transmitting the RRC reconfiguration complete indication, at least one of a MAC-CE or DCI associated with the RRC reconfiguration request. The apparatus 1204, and in particular the cellular baseband processor 1224 and/or the application processor 1206, may include means for scheduling, in response to the RRC reconfiguration request, at least one gap in UL transmission and DL reception via a primary carrier to coincide with one or more time periods based on a known configuration for communication with a network node associated with the carrier aggregation. The apparatus 1204, and in particular the cellular baseband processor 1224 and/or the application processor 1206, may include means for performing a first set of RRC reconfiguration operations associated with a first set of parameters corresponding to at least the primary carrier of the carrier aggregation. The apparatus 1204, and in particular the cellular baseband processor 1224 and/or the application processor 1206, may include means for performing a first set of RRC reconfiguration operations associated with a first set of parameters corresponding to at least the primary carrier of the carrier aggregation. The apparatus 1204, and in particular the cellular baseband processor 1224 and/or the application processor 1206, may include means for performing, during the at least one gap in the uplink transmission and the downlink reception via the primary carrier, a second set of RRC reconfiguration operations associated with a second set of parameters corresponding to at least one non-primary carrier of the carrier aggregation. The means may be the RRC reconfiguration component 198 of the apparatus 1204 configured to perform the functions recited by the means or any of the functions describe in relation to FIGS. 8-11. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

In some aspects of wireless communication, e.g., a RRC reconfiguration operation may be associated with a time limit between a RRC reconfiguration request and a RRC reconfiguration complete. After the time limit, a base station may transmit an activation indication associated with the RRC reconfiguration request. For a RRC reconfiguration request associated with carrier aggregation, the time limit may be shorter than a time for completing RF tuning. RF tuning operations associated with SCC other than a PCC of the carrier aggregation may be associated with interruptions to reception via the primary component carrier. In some aspects, the interruptions may coincide with an activation indication associated with the RRC reconfiguration request such that the activation indication is not received and the RRC reconfiguration may fail (e.g., a SCC associated with the activation indication may not be activated).

Methods and apparatus are provided to reduce the likelihood of failed RRC reconfigurations. For example, a UE may be configured to implement a modified timeline of operations associated with a RRC reconfiguration request. The modified timeline, in some aspects, may be associated with one or more of modified scheduling of operations associated with the RRC reconfiguration request, modified scheduling of a RRC reconfiguration complete transmission, or a modified scheduling of Rx blanking (e.g., interruptions to reception via a PCC) for RF tuning operations associated with at least one SCC as will be further described below.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including receiving a RRC reconfiguration request associated with carrier aggregation; performing a first set of RRC reconfiguration operations associated with a first set of physical layer parameters, in response to the RRC reconfiguration request; transmitting, based on completing performing the first set of RRC reconfiguration operations, an RRC reconfiguration complete indication; and performing, after transmitting the RRC reconfiguration complete indication, a second set of RRC reconfiguration operations associated with a second set of parameters other than the first set of physical layer parameters.

Aspect 2 is the method of aspect 1, where transmitting the RRC reconfiguration complete indication is further based on a timer beginning at the receiving of the RRC reconfiguration request associated with the carrier aggregation and occurs before the timer reaches a known threshold time.

Aspect 3 is the method of any of aspects 1 and 2, where the second set of parameters include a set of RF parameters.

Aspect 4 is the method of any of aspects 1 to 3, where the second set of RRC reconfiguration operations is associated with a primary carrier of the carrier aggregation.

Aspect 5 is the method of aspect 4, where the second set of RRC reconfiguration operations is associated with a continuous period of at least one of reception or transmission via the primary carrier for completing an RRC reconfiguration procedure associated with the RRC reconfiguration request.

Aspect 6 is the method of aspect 5, further including omitting a set of RF tuning operations associated with non-primary carriers for the RRC reconfiguration procedure.

Aspect 7 is the method of aspect 6, where the set of RF tuning operations includes operations associated with an inability to receive a transmission via the primary carrier.

Aspect 8 is the method of any of aspects 1 to 7, further including receiving, at a time based on transmitting the RRC reconfiguration complete indication, at least one of a MAC-CE or DCI associated with the RRC reconfiguration request.

Aspect 9 is a method of wireless communication at a UE, including receiving a RRC reconfiguration request associated with carrier aggregation and scheduling, in response to the RRC reconfiguration request, at least one gap in uplink transmission and downlink reception via a primary carrier to coincide with one or more time periods based on a known configuration for communication with a network node associated with the carrier aggregation.

Aspect 10 is the method of aspect 9, further including performing a first set of RRC reconfiguration operations associated with a first set of parameters corresponding to at least the primary carrier of the carrier aggregation and performing, during the at least one gap in the uplink transmission and the downlink reception via the primary carrier, a second set of RRC reconfiguration operations associated with a second set of parameters corresponding to at least one non-primary carrier of the carrier aggregation.

Aspect 11 is the method of aspect 10, where the second set of RRC reconfiguration operations includes a set of RF tuning operations associated with the at least one non-primary carrier.

Aspect 12 is the method of any of aspects 9 to 11, where at least one time period includes one or more uplink subframes of a TDD configuration.

Aspect 13 is the method of aspect 12, where the one or more uplink subframes include uplink subframes that are not associated with a feedback transmission.

Aspect 14 is the method of any of aspects 9 to 13, where the one or more time periods include at least a first time period avoiding a window associated with receiving at least one of a carrier aggregation activation or a resource grant associated with the RRC reconfiguration request.

Aspect 15 is the method of aspect 14, where the carrier aggregation activation is associated with a MAC-CE or the resource grant is associated with DCI.

Aspect 16 is an apparatus for wireless communication at a device (e.g., a UE) including a memory and at least one processor coupled to the memory and, based at least in part on information stored in the memory, the at least one processor is configured to implement any of aspects 1 to 15.

Aspect 17 is the apparatus of aspect 16, further including a transceiver or an antenna coupled to the at least one processor.

Aspect 18 is an apparatus for wireless communication at a device including means for implementing any of aspects 1 to 15.

Aspect 19 is a computer-readable medium (e.g., a non-transitory computer-readable medium) storing computer executable code, where the code when executed by a processor causes the processor to implement any of aspects 1 to 15.

What is claimed is:

1. An apparatus for wireless communication at a wireless device, comprising:
a memory; and
at least one processor coupled to the memory and, based at least in part on information stored in the memory, the at least one processor is configured to:
receive a radio resource control (RRC) reconfiguration request associated with carrier aggregation;
perform a first set of RRC reconfiguration operations associated with a first set of physical layer parameters, in response to the RRC reconfiguration request;
transmit, based on completing performing the first set of RRC reconfiguration operations, an RRC reconfiguration complete indication; and
perform, after transmitting the RRC reconfiguration complete indication, a second set of RRC reconfiguration operations associated with a second set of parameters other than the first set of physical layer parameters.

2. The apparatus of claim 1, wherein the at least one processor is configured to transmit the RRC reconfiguration complete indication further based on a timer beginning at the reception of the RRC reconfiguration request associated with the carrier aggregation, and wherein the at least one processor is configured to transmit the RRC reconfiguration complete indication before the timer reaches a known threshold time.

3. The apparatus of claim 1, wherein the second set of parameters includes a set of radio frequency (RF) parameters.

4. The apparatus of claim 1, wherein the second set of RRC reconfiguration operations is associated with a primary carrier of the carrier aggregation.

5. The apparatus of claim 4, wherein the second set of RRC reconfiguration operations is associated with a continuous period of at least one of reception or transmission via the primary carrier for completing an RRC reconfiguration procedure associated with the RRC reconfiguration request.

6. The apparatus of claim 5, wherein the at least one processor is further configured to:
omit a set of radio frequency (RF) tuning operations associated with non-primary carriers for the RRC reconfiguration procedure.

7. The apparatus of claim 6, wherein the set of RF tuning operations comprises operations associated with an inability to receive the transmission via the primary carrier.

8. The apparatus of claim 1, further comprising a transceiver coupled to the at least one processor, wherein the at least one processor is configured to:
receive, via the transceiver at a time based on transmitting the RRC reconfiguration complete indication, at least one of a medium access control (MAC) control element (CE) (MAC-CE) or downlink control information (DCI) associated with the RRC reconfiguration request.

9. An apparatus for wireless communication at a wireless device, comprising:
a memory; and
at least one processor coupled to the memory and, based at least in part on information stored in the memory, the at least one processor is configured to:
receive a radio resource control (RRC) reconfiguration request associated with carrier aggregation; and
schedule, in response to the RRC reconfiguration request, at least one gap in uplink transmission and downlink reception via a primary carrier to coincide with one or more time periods based on a known configuration for communication with a network node associated with the carrier aggregation.

10. The apparatus of claim 9, wherein the at least one processor is configured to:
perform a first set of RRC reconfiguration operations associated with a first set of parameters corresponding to at least the primary carrier of the carrier aggregation; and
perform, during the at least one gap in the uplink transmission and the downlink reception via the primary carrier, a second set of RRC reconfiguration operations associated with a second set of parameters corresponding to at least one non-primary carrier of the carrier aggregation.

11. The apparatus of claim 10, wherein the second set of RRC reconfiguration operations comprises a set of radio frequency (RF) tuning operations associated with the at least one non-primary carrier.

12. The apparatus of claim 9, wherein at least one time period comprises one or more uplink subframes of a time division duplex (TDD) configuration.

13. The apparatus of claim 12, wherein the one or more uplink subframes comprise uplink subframes that are not associated with a feedback transmission.

14. The apparatus of claim 9, wherein the one or more time periods comprise at least a first time period avoiding a window associated with receiving at least one of a carrier aggregation activation or a resource grant associated with the RRC reconfiguration request.

15. The apparatus of claim 14, further comprising a transceiver coupled to the at least one processor, wherein to receive the RRC reconfiguration request, the at least one processor is configured to receive the RRC reconfiguration request via the transceiver, and wherein the carrier aggregation activation is associated with a medium access control (MAC) control element (CE) (MAC-CE) or the resource grant is associated with downlink control information (DCI).

16. A method for wireless communication at a wireless device, comprising:
receiving a radio resource control (RRC) reconfiguration request associated with carrier aggregation;
performing a first set of RRC reconfiguration operations associated with a first set of physical layer parameters, in response to the RRC reconfiguration request;
transmitting, based on completing performing the first set of RRC reconfiguration operations, an RRC reconfiguration complete indication; and
performing, after transmitting the RRC reconfiguration complete indication, a second set of RRC reconfiguration operations associated with a second set of parameters other than the first set of physical layer parameters.

17. The method of claim 16, wherein transmitting the RRC reconfiguration complete indication is further based on a timer beginning at the reception of the RRC reconfiguration request associated with the carrier aggregation and occurs before the timer reaches a known threshold time.

18. The method of claim 16, wherein the second set of parameters include a set of radio frequency (RF) parameters.

19. The method of claim 16, wherein the second set of RRC reconfiguration operations is associated with a primary carrier of the carrier aggregation.

20. The method of claim 19, wherein the second set of RRC reconfiguration operations is associated with a continuous period of at least one of reception or transmission via the primary carrier for completing an RRC reconfiguration procedure associated with the RRC reconfiguration request.

21. The method of claim 20, further comprising:
omitting a set of radio frequency (RF) tuning operations associated with non-primary carriers for the RRC reconfiguration procedure.

22. The method of claim 21, wherein the set of RF tuning operations comprises operations associated with an inability to receive the transmission via the primary carrier.

23. The method of claim 16, further comprising:
receiving, at a time based on transmitting the RRC reconfiguration complete indication, at least one of a medium access control (MAC) control element (CE) (MAC-CE) or downlink control information (DCI) associated with the RRC reconfiguration request.

24. A method for wireless communication at a wireless device, comprising:
receiving a radio resource control (RRC) reconfiguration request associated with carrier aggregation; and
scheduling, in response to the RRC reconfiguration request, at least one gap in uplink transmission and downlink reception via a primary carrier to coincide with one or more time periods based on a known configuration for communication with a network node associated with the carrier aggregation.

25. The method of claim 24, further comprising:
performing a first set of RRC reconfiguration operations associated with a first set of parameters corresponding to at least the primary carrier of the carrier aggregation; and
performing, during the at least one gap in the uplink transmission and the downlink reception via the primary carrier, a second set of RRC reconfiguration operations associated with a second set of parameters corresponding to at least one non-primary carrier of the carrier aggregation.

26. The method of claim 25, wherein the second set of RRC reconfiguration operations comprises a set of radio frequency (RF) tuning operations associated with the at least one non-primary carrier.

27. The method of claim 24, wherein at least one time period comprises one or more uplink subframes of a time division duplex (TDD) configuration.

28. The method of claim 27, wherein the one or more uplink subframes comprise uplink subframes that are not associated with a feedback transmission.

29. The method of claim 24, wherein the one or more time periods comprise at least a first time period avoiding a window associated with receiving at least one of a carrier aggregation activation or a resource grant associated with the RRC reconfiguration request.

30. The method of claim 29, wherein the carrier aggregation activation is associated with a medium access control (MAC) control element (CE) (MAC-CE) or the resource grant is associated with downlink control information (DCI).
